(19) United States
(12) Patent Application Publication
(10) Pub. No.: US 2023/0316138 A1
(43) Pub. Date: Oct. 5, 2023

(54) SHARING AI-CHAT BOT CONTEXT

(71) Applicant: IfElse Inc., WILMINGTON, DE (US)

(72) Inventors: Bill Nguyen, Wilmington, DE (US); Jacob Justice, Wilmington, DE (US)

(21) Appl. No.: 18/114,426

(22) Filed: Feb. 27, 2023

Related U.S. Application Data
(60) Provisional application No. 63/326,145, filed on Mar. 31, 2022.

(51) Int. Cl. G06N 20/00; H04L 51/02

(52) U.S. Cl. CPC G06N 20/00; H04L 51/02

(57) ABSTRACT

Systems and methods are disclosed for sharing artificial intelligence bot context. The systems and methods perform operations comprising: receiving a set of data corresponding to a context of a first conversation between a first user and a first chat bot, the first chat bot comprising a first machine learning model; updating one or more parameters of a second chat bot based on the set of data, the second chat bot comprising a second machine learning model; receiving a first query from a second user; after updating the one or more parameters of the second chat bot, processing the first query with the second chat bot to generate a first response to the first query received from the second user based on a context of the first conversation between the first user and the first chat bot; and presenting the first response to the second user. The system is not limited by an adoption of a second chat bot to a first chat bot conversation. The system can be implemented to facilitate many to many interactions

### PRIORITY APPLICATIONS

This application claims the benefit of priority to U.S. Provisional Patent Application Ser. No. 63/326,145, filed Mar. 31, 2022, the content of which is incorporated herein by reference in its entirety.

### TECHNICAL FIELD

The present disclosure relates generally to AI-Chat bots.

### BACKGROUND

The trend for human communication continues to evolve through asynchronous modality such as text messaging, email, and posts on social media. Such forms allow for conversations to occur conveniently at each recipient's convenience. With ever increasing volumes of communication, people with mobile and Internet access account for nearly a trillion messages each day. The “always-on” and connected world creates often redundant communications, resulting in more presentational, shorter, and less genuine dialogue. Impacting the trend of communications is the recent advancement of artificial intelligence (AI). Some AI has been applied to solving deterministic tasks such turning ON lights or getting direction through services such as Apple Siri and Google's Assistant. The interactions between humans and AI is typically in the form of “task and deliver.” Adding AI into asynchronous communications adds shared context, making disparate conversations more real-time and relevant.

### BRIEF DESCRIPTION OF THE DRAWINGS

Various ones of the appended drawings merely illustrate some examples of the present disclosure and should not be considered as limiting its scope.

FIG. 1 is a block diagram illustrating a networked system for a chat bot system, according to some examples.

FIG. 2 illustrates an AI-bot sharing system, according to some examples.

FIGS. 3 and 4 illustrate flow diagrams of processes of the AI-bot sharing system, according to some examples.

FIG. 5 is an illustrative graphical user interface of the AI-bot sharing system, according to some examples.

FIG. 6 is a block diagram illustrating an example of a software architecture that may be installed on a machine, according to some examples.

FIG. 7 illustrates a diagrammatic representation of a machine, in the form of a computer system, within which a set of instructions may be executed for causing the machine to perform any one or more of the methodologies discussed herein, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples. It will be evident, however, to those skilled in the art, that examples may be practiced without these specific details. In general, well-known instruction instances, protocols, structures, and techniques are not necessarily shown in detail.

Users typically spend a great deal of time and effort interacting with virtual assistants in the form of chat bots to accomplish various tasks. For example, chat bots are typically implemented in various customer service industries to reduce the amount of live human resources needed to address various customer issues. Such chat bots are programmed to respond in the same way to each customer through a series of questions and answers or responses. The existing chat bots can leverage some amount of a user's profile to direct certain questions and answers relevant to a given user. However, the existing chat bots can sometimes frustrate users who have different levels of experience or who are seeking answers or a solution to a problem that was already addressed for other users. Specifically, if a new user begins interacting with a chat bot, that new user has to perform the same series of steps another user has performed to reach a certain outcome or resolution. These series of steps can be redundant and can take a great deal of time, which ends up wasting resources and frustrates users. The new user may be aware of another user's interaction with the chat bot that led to some desirable solution but the new user has no way to informing the chat bot or leveraging the other user's historical interactions to achieve a similar outcome.

Some typical chat bots are able to deliver certain responses to users who pose a certain query to the chat bot. For example, a user can ask verbally or in written form a question and the chat bot can seek out a response to the question, such as by searching the Internet or other information sources. The level of experience of the user who is posing the query may not be known and, as a result, a generically formed response is usually delivered. Even when profile data is stored in “cookies”, the intent of the user is assumed and not deterministically certain. Some users may have background knowledge about a topic for they are seeking information and typical systems have no way of leveraging such background knowledge about the user in delivering responses. Training such systems to recognize and leverage the user's background knowledge can take a great deal of time and many interactions with the system to build a particular profile for the user to appropriately deliver responses that are suitable to the user based on the user's level of experience. Users may not have the time it takes to train such systems, which results in responses that are usually uninformative, which in turn often lead to lack of use and waste of resources.

According to the disclosed techniques, an AI-chat bot sharing system is provided that allows one user to deterministically chose and benefit from the conversations another user experiences or shares with their personal AI. The shared AI is adopted and can begin to meld the context of the one conversation with another user's conversation. In this way, the disclosed examples improve the efficiency of using an electronic device to provide a better way for users to interact with AI-chat bot systems. Specifically, one user can share their conversation with their respective AI-chat bot with one or more other users. The recipients can view details or a description of the conversation and can select an option to adopt the conversation into their own AI-chat bot. In response to receiving a selection of the option to adopt the conversation, the AI-chat bot of the recipient users is updated to provide or generate responses that consider the conversation context of another user. This provides a more engaging and seamless experience that is more enjoyable to a user. From a functional level, this also reduces frustration by allowing the user to guide their intent based on an intended conversational outcome.

For example, a user interface can be provided that lists different levels of user experience and their respective problems and solutions provided by way of interaction with their AI-chat bots. A user selection can be received from a second user that identifies a particular level of user experience, and a set of data (e.g., parameters of a machine learning model) associated with the AI-chat bot is retrieved and used to update the chat bot of the second user. Now, when the second user interacts with the updated chat bot, the set of responses to the query are generated based on the selected particular level of user experience or political view, which improves the overall response quality. In some cases, the different levels of experience of users result in different levels of detail that are provided as part of the responses of the AI-chat bot. This way, a particular user who has a particular level of experience (or political view) can be provided with a specified amount of detail (more or less detail) about a topic of interest than another user with different level of experience (or different political view). This can be performed in response to input from the particular user that selects an option to adopt a previous conversation of an AI-chat bot with another user having the particular level of experience into the AI-chat bot of the particular user.

In some examples, a set of data corresponding to a context of a first conversation between a first user and a first chat bot is received. The first chat bot can include a first machine learning model. In response to receiving the set of data, one or more parameters of a second chat bot are updated based on the set of data. The second chat bot includes a second machine learning model. A first query can be received from a second user after updating the one or more parameters of the second chat bot. The first query is processed with the second chat bot to generate a first response to the first query based on the context of the first conversation between the first user and the first chat bot. The first response is then presented to the second user.

In this way, the amount of time and effort the user has to spend searching for a response to a query are significantly reduced. Also, by providing an AI-chat bot that automatically considers interactions other users have had with their respective AI-chat bots in providing responses to the user, the number of steps, pages, and interfaces the user has to navigate to obtain information are reduced.

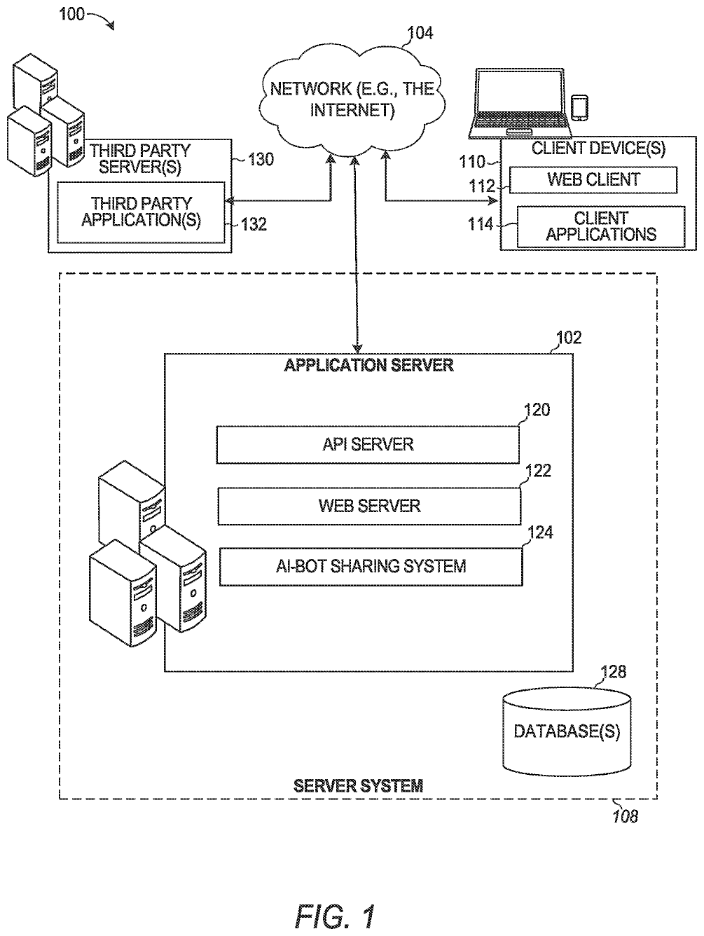

FIG. 1 is a block diagram illustrating a networked system 100 for an AI-chat bot system, according to some examples. The system 100 includes one or more client devices such as client device 110. The client device 110 can include a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, headwear, smart glasses, smartwatch, or any other communication device that a user may utilize to access the networked system 100. In some examples, the client device 110 includes a display module to display information (e.g., in the form of graphical user interfaces). In further examples, the client device 110 includes one or more of touch screens, accelerometers, gyroscopes, cameras, microphones, global positioning system (GPS) devices, and so forth. The client device 110 may be a device of a user that is used to access and utilize AI-chat bot systems via an AI-bot sharing system 124 implemented by an application server 102.

For example, the client device 110 may be used by a user to navigate to a website or server of the AI-bot sharing system 124. In some examples, the client device 110 may include a dedicated AI-bot sharing system 124 application with the same or similar functionality as the website or server. Any functionality described with respect to the AI-bot sharing system 124 (or AI-chat bot sharing system) that is implemented on the application server 102 can be performed exclusively or in a distributed manner on respective client devices 110. The AI-bot sharing system 124 can implement a plurality of AI-chat bots, with each associated with a different user or client device 110. Each AI-chat bot can be implemented by a machine learning model (e.g., a neural network) and trained to provide responses to queries transmitted or received from one or more users. Namely, parameters of the AI-chat bot can be used to generate a suitable response to a query that is in a structured or unstructured language format. In some examples, the AI-chat bot can access one or more information sources over the Internet (e.g., a Wikipedia or encyclopedia) and/or one or more social networks and/or a user profile to formulate and generate a suitable response. The AI-chat bot allows the user to provide queries in the form of text, speech, image, or video and can generate and output responses in the same or different form, such as text, speech, image, or video.

In some examples, after accessing the website, the user inputs personal information (e.g., name, address, phone number, payment information, and so forth) to subscribe to the AI-bot sharing system 124 to be provided with the disclosed sharing functionalities. In some examples, the subscription fee is paid monthly but can be paid on any other periodic interval (e.g., weeks, daily, every other month, annual, lifetime, and so forth). After subscribing to the AI-bot sharing system 124, the user is provided with login credentials that can be used to navigate and browse available shared conversations on the AI-bot sharing system 124 to clone into the AI-bot implemented on the client device 110 of the user. Namely, once a conversation or context or personality of interest is found on the AI-bot sharing system 124, input can be received from the user to retrain or update the AI-chat bot that is associated with the user. In response to such input, the parameters of the first machine learning model of the AI-bot associated with the first user are updated to clone or copy the conversation or context or personality of interest associated with a second user that is selected.

In some examples, the parameters of the first machine learning model are updated by retrieving one or more parameters of a second machine learning model corresponding to the conversation or context or personality of interest of the second user that is selected and replacing, adding, or modifying the parameters of the first machine learning model with the retrieved parameters. This enhances privacy protection as the underlying conversation data of the second user is not received or shared but only the parameters of the second machine learning model that represent such a conversation. The intention is to recreate some of the benefits of personalization through cookies but without the concerns and limitations of disclosing personally identifiable information. In some examples, the underlying conversation snippet or content (including one or more messages exchanged between the second user and the second machine learning model) are used to retrain the parameters of the first machine learning model to provide the same conversation or context or personality of interest that is selected.

One or more users may be a person, a machine, or other means of interacting with the client device 110. In some examples, the user may not be part of the system 100 but may interact with the system 100 via the client device 110 or other means. For instance, the user may provide input (e.g., touch screen input or alphanumeric input) to the client device 110 and the input may be communicated to other entities in the system 100 (e.g., third-party servers 130, server system 108, etc.) via a network 104. In this instance, the other entities in the system 100, in response to receiving the input from the user, may communicate information to the client device 110 via the network 104 to be presented to the user. In this way, the user interacts with the various entities in the system 100 using the client device 110.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via a web client 112 (e.g., a browser, such as the Internet Explorer® browser developed by Microsoft® Corporation of Redmond, Washington State) or one or more client applications 114. The client device 110 may include one or more client applications 114 (also referred to as “apps”) such as, but not limited to, a web browser, messaging application, electronic mail (email) application, an e-commerce site application, a mapping or location application, an online home buying and selling application, a travel services application, a real estate application, an AI-chat bot application, and the like.

In some examples, one or more client applications 114 are included in a given one of the client device 110 and configured to locally provide the user interface and at least some of the functionalities, with the client application 114 configured to communicate with other entities in the system 100 (e.g., third-party servers 130, server system 108, etc.), on an as-needed basis, for data and/or processing capabilities not locally available (e.g., to access location information, to access travel services information, such as cost and availability, to authenticate a user, to verify a method of payment, etc.). Conversely, one or more applications 114 may not be included in the client device 110, and then the client device 110 may use its web browser to access the one or more applications hosted on other entities in the system 100 (e.g., third-party servers 130, server system 108, etc.).

A server system 108 provides server-side functionality via the network 104 (e.g., the Internet or WAN) to one or more third-party servers 130 and/or one or more client devices 110. The server system 108 includes an application server 102 that implements an application program interface (API) server 120, a web server 122, and the AI-bot sharing system 124, that may be communicatively coupled with one or more databases 128. The one or more databases 128 may be storage devices that store data related to users of the system 108, applications associated with the system 108, cloud services, conversation data, one or more machine learning techniques (or machine learning models) and so forth. The one or more databases 128 may further store information related to third-party servers 130, third-party applications 132, client devices 110, client applications 114, users, and so forth. In some examples, the one or more databases 128 may be cloud-based storage.

In some examples, the one or more databases 128 may be cloud-based storage. The one or more databases 128 may store past conversation data or interaction data for one or more users. The one or more databases 128 can store the parameters of the individual machine learning models that implement the respective AI-chat bots for different users of the system. The one or more databases 128 can store descriptions of different cloned conversations or shared conversations or personalities of different AI-chat bots. These descriptions can be presented on a webpage or graphical user interface for other users to browse. These descriptions can also be stored as meta data to exchange as ingredients in a more complex combination. The other users can select the descriptions which are then used to retrieve a corresponding given set data representing context of conversations to adopt into their own AI-chat bots. The one or more databases 128 can also store a counter for each set of conversations that indicate the number of times the corresponding set of data has been cloned or adopted. This enables the graphical user interface to sort the set of available data corresponding to the different conversation contexts according to popularity (e.g., higher value counters can represent higher popularity).

The one or more databases 128 can also store geographical restrictions for each of the set data representing context of conversations. Such geographical restrictions can be used to impose a geo-fence around each of the set data representing context of conversations to limit which set data representing context of conversations are presented to particular users on a graphical user interface based on the current location of the users. For example, a user that is using a client device 110 in a first geographical location can access the graphical user interface to obtain a set data representing context of conversations. The first geographical location can be used to search the one or more databases 128 for the set data representing context of conversations that is associated with a geo-fence that is within a threshold distance (e.g., 10 miles) of the first geographical location. As such, the graphical user interface can be presented on the client device 110 that includes a first subset of the set data representing context of conversations. A user can be using a client device 110 in a second geographical location to access the graphical user interface to obtain a set data representing context of conversations. The second geographical location can be used to search the one or more databases 128 for the set data representing context of conversations that is associated with a geo-fence that is within a threshold distance (e.g., 10 miles) of the second geographical location. As such, the graphical user interface can be presented on the client device 110 at the second geographical location that includes a second subset of the set data representing context of conversations different from the first subset. This prevents users from cloning conversation contexts that are beyond their current geographical locations by more than a threshold distance.

The server system 108 may be a cloud computing environment, according to some examples. The server system 108, and any servers associated with the server system 108, may be associated with a cloud-based application, in some examples.

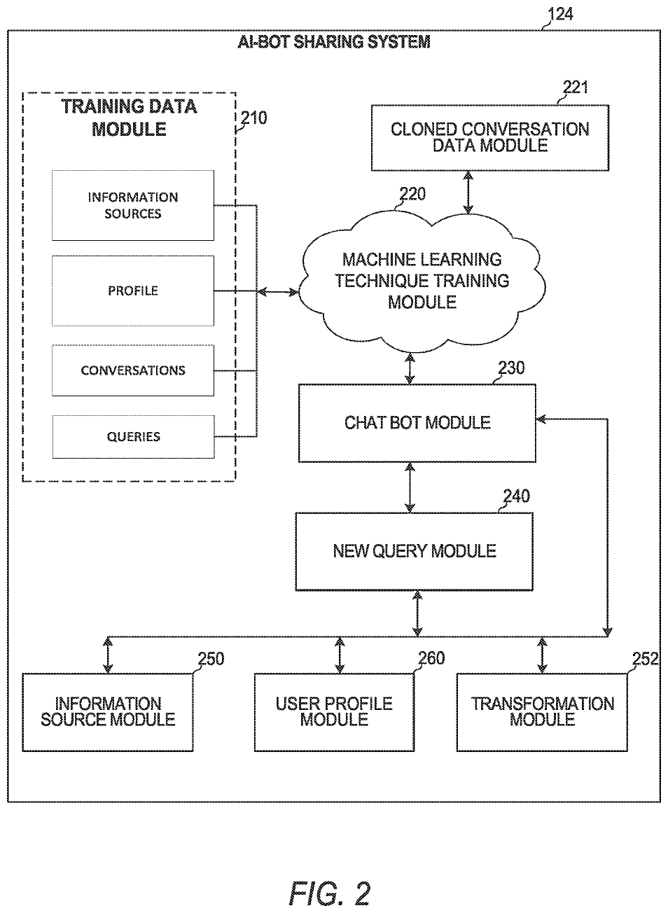

The server system 108 includes the AI-bot sharing system 124. The AI-bot sharing system 124 includes one or more modules, storage devices, and databases. The modules in the AI-bot sharing system 124 are configured to train a machine learning technique to generate a response to a query received from a client device 110 by establishing relationships between known (training or ground truth) responses and known (training or ground truth) queries. The modules in AI-bot sharing system 124 are configured to enable a user of a first client device 110 that implements or access a first AI-chat bot to replicate, adopt, and/or clone a context of a conversation that a different user of a second client device 110 had with a second AI-chat bot (different from the first AI-chat bot). The details of the AI-bot sharing system 124 are provided below in connection with FIG. 2.

For example, the second user may interact by way of the second client device 110 with the second AI-chat bot for a period of time, such as one day, one week, one year, one second, or any other suitable threshold time period. During the interaction, the second AI-chat bot learns certain behaviors, interest levels, experience levels, and levels of detail of the user. These can be referred to as contexts associated with the conversation or interaction. For example, the second AI-chat bot can learn over time that the second user may have a first political affiliation or views or has a first level of experience with a subject and likes to receive responses with a first level of detail. The second client device 110 can receive input from the second user requesting to share the context of the second AI-chat bot. The context can be associated with a portion of the conversation that the user had with the AI-chat bot at a particular time, one or more messages that were exchanged, the entire history of conversations or interactions, or any other suitable representation of the interactions the second user had with the second AI-chat bot. The second client device 110 can associate a description (e.g., input by the user or automatically generated based on keywords of the conversation) with the context.

The second client device 110 can then share the description and a link to the set of data corresponding to the context with one or more other users through a message. The message can be encrypted or unencrypted. The message can be a directed communication from the second client device 110 to the first client device 110 (e.g., an SMS or text message) or can be posted on a public or private website, forum, blog, social media network page, or article. The first client device 110 can receive the message (e.g., by way of the direct communication or by selecting the message from the website where it is shared) and can receive input from the first user selecting an option to clone or adopt the set of data corresponding to the context of the second user. In response, the first client device 110 can use the data associated with the context to re-train or update parameters of the first AI-chat bot associated with the first client device 110. In this way, the first client device 110 can receive a query from the first user and can use the first AI-chat bot to generate a response to the query using the set of data corresponding to the context of the second user.

For example, the response generated by the first AI-chat bot can represent the first political affiliation or views or the first level of experience with respect to the subject and the first level of detail that the second AI-chat bot was trained to generate. In this way, the first user can avoid having to spend the period of time training the first AI-chat bot to generate such responses as this period of time spent training the second AI-chat bot has already been spent by the second user. As such, the first user can pick up where the second user has left off in a conversation context. In some examples, prior to updating the first AI-chat bot to represent the first political affiliation or views or the first level of experience with respect to the subject and the first level of detail of the second user, the first AI-chat bot can be trained to generate a first type of response to a particular query. After updating the first AI-chat bot to represent the first political affiliation or views or the first level of experience with respect to the subject and the first level of detail of the second user, the first AI-chat bot becomes trained to generate a second type of response to the same particular query.

The system 100 further includes one or more third-party servers 130. The one or more third-party servers 130 may include one or more third-party application(s) 132. The one or more third-party application(s) 132, executing on third-party server(s) 130, may interact with the server system 108 via API server 120 via a programmatic interface provided by the API server 120. For example, one or more the third-party applications 132 may request and utilize information from the server system 108 via the API server 120 to support one or more features or functions on a website hosted by the third party or an application hosted by the third party. The third-party website or application 132, for example, may provide software version analysis functionality that is supported by relevant functionality and data in the server system 108. Third-party servers 130 may implement an AI-chat bot system, such as portions of the AI-bot sharing system 124. In some examples, a conversation context or data associated with the conversation context can be provided to the third-party servers 130 to enable users outside of the application server 102 to access this data to train their respective AI-chat bots.

FIG. 2 illustrates the AI-bot sharing system 124, according to some examples. The AI-bot sharing system 124 includes a training data module 210, a machine learning technique training module 220 (also referred to as machine learning model), a chat bot module 230 (also referred to as trained machine learning model), a new query module 240, an information source module 250, a user profile module 260, a cloned conversation data module 221, and a transformation module 252. In some implementations, some modules of the AI-bot sharing system 124 may be implemented on server system 108 and others may be implemented on third party servers 130 and/or client device 110. In some implementations, all of the modules of the AI-bot sharing system 124 are implemented on server system 108, on third-party servers 130, or on respective client devices 110. In such cases, server system 108 communicates information to third-party servers 130 based on the modules implemented and vice versa.

The new query module 240 may communicate with the client device 110 to receive a query from a user. The query can be received by way of a structured or unstructured language format. The query can be received verbally, in written or textual form, or by way of other visual form. For example, via the graphical user interface of the client device 110, the user can type in a query or question or command. The new query module 240 may communicate this query to the chat bot module 230. The new query module 240 may also communicate an identifier of the user of the client device 110 to the chat bot module 230.

The chat bot module 230 can implement a machine learning model that is trained by the machine learning technique training module 220. The chat bot module 230 can implement a plurality of AI-chat bots (e.g., a plurality of machine learning models) each associated with a different user or client device 110. The chat bot module 230 can receive an identifier of the user and can select a chat bot from the plurality of machine learning models or chat bots that is associated with the identifier of the user. For example, the chat bot module 230 can select a first AI-chat bot that is associated with a first user.

Each of the AI-chat bots implemented by the chat bot module 230 is trained to receive a query and generate a suitable response to the query in textual, audible, or visual form. In some examples, the chat bot module 230 communicates with the transformation module 252 to transform the query that is received into a suitable form. For example, the transformation module 252 can transcribe the query into textual form and can identify entities and intent of the query. Using the entities and intent, the chat bot module 230 accesses a user profile module 260 (based on the identifier of the user) to determine interests of the user. The chat bot module 230 then uses the entities and intent and interest of the user to select a subset of information sources from the information source module 250 to search for a response. For example, the information source module 250 can provide access to various information sources, such as news sources, encyclopedia sources, social media network sources, and so forth. The user profile and the entities and intent of the query can instruct the chat bot module 230 which of the various information sources of the information source module 250 to access to obtain a result. The chat bot module 230 can use keywords of the textual form of the query together with preferences of the user profile obtained from the user profile module 260 to obtain data from the information source module 250. The chat bot module 230 can then apply parameters of the machine learning model to aggregate or assemble a response that represents the obtained data. The response can have different levels of detail based on the parameters of the machine learning model.

In some examples, the chat bot module 230 can generate a response that is in a structured or unstructured format. The chat bot module 230 can visually, audibly, or textually represent the response to the user via the graphical user interface of the client device 110. In some examples, the graphical user interface resembles a chat or conversation interface. A first set of messages in the conversation interface can be received from the client device 110 and represent queries and a second set of messages can represent responses generated by the chat bot module 230.

To generate responses to queries, each machine learning model implemented by the chat bot module 230 is trained by the machine learning technique training module 220 based on training data. Specifically, the training data module 210 includes data that is used to establish relationships between known queries and corresponding responses. Based on this relationship, a new query can be received and a response generated. The training data module 210 can include information sources, profile information, past conversations (including queries and responses), and a set of queries.

Machine learning technique training module 220 is trained to predict or generate a response for a subscriber or user of the AI-bot sharing system 124 by establishing a relationship between one or more known responses provided to other users based on queries received from those users and/or any of the information provided by the training data module 210. Additional responses or input from a user interaction may be interested to constantly recalculate and adapt responses.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data (e.g., travel services activity information) in order to make data-driven predictions or decisions expressed as outputs or assessments. Although some examples are presented with respect to a few machine-learning tools, the principles presented herein may be applied to other machine-learning tools. In some examples, different machine-learning tools may be used. For example, Logistic Regression (LR), linear regression, Naive-Bayes, Random Forest (RF), neural networks (NN), matrix factorization, and Support Vector Machines (SVM) tools may be used for generating responses to queries.

The machine-learning algorithms utilize features (e.g., various combinations of queries received from other users in interacting with the AI-bot sharing system 124) for analyzing the data to generate responses. A feature is an individual measurable property of a phenomenon being observed. The concept of a feature is related to that of an explanatory variable used in statistical techniques such as linear regression. Choosing informative, discriminating, and independent features is important for effective operation in pattern recognition, classification, and regression. Features may be of different types, such as numeric features, strings, and graphs.

In some examples, the features may be of different types and may include one or more of a set of queries, a collection of conversations (queries and responses), information source information, profile information, responses, and so forth. The machine-learning algorithms utilize the training data to find correlations among the identified features that affect the outcome or assessment (e.g., the known response to each query). In some examples, the training data includes labeled data, which is known data for one or more identified features and one or more outcomes, such as the response to each query.

Once the training data are collected and processed, machine learning technique training module 220 model can be built using either statistical learning or machine learning techniques. In one example, regression analysis can be used to build the machine learning technique training module 220 model. Regression analysis is a statistical process for estimating the relationships among variables. There are a number of known methods to perform regression analysis. Linear regression or ordinary least squares regression, among others, are “parametric” in that the regression function is defined in terms of a finite number of unknown model parameters that can be estimated from training data. For example, a regression model (e.g., Equation 1) can be defined, for example, as:

H≈f(X,β), (Equation 1)

where “H” denotes the known response to a set of queries, “X” denotes a vector of input variables (e.g., any one of the set of queries or data in the training data module 210), and “β” denotes a vector of unknown parameters to be determined or trained for the regression model.

The training data that include queries or conversations received from other users and the corresponding responses (which can be manually or automatically specified) provide a set of known H values (e.g., the responses) having corresponding X values (e.g., feature vectors extracted from the queries or conversations received from other users). Using these data, the model parameter β can be computed using data fitting techniques such as least squares, maximum likelihood, or the like. Once β is estimated, the model can then compute H (e.g., a response) for a new set of X values (e.g., feature vectors extracted from a new query).

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised, indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, RF, decision tree learning, NN, deep NN, and so forth.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some examples, models that are finalized are evaluated against testing criteria. In a first example, a testing dataset that includes known outputs for its inputs is fed into the finalized models to determine an accuracy of the model in handling data on which it is has not been trained. In a second example, a false positive rate or false negative rate may be used to evaluate the models after finalization. In a third example, a delineation between data clusterings is used to select a model that produces the clearest bounds for its clusters of data. In some examples, the machine learning technique training module 220 is trained to establish a relationship to classify a user based on a logistic regression of one or more features (e.g., training data received from training data module 210).

After being trained, the machine learning technique is provided to chat bot module 230. In one example, the coefficient values or parameters of the machine learning technique (e.g., the linear model) are stored in a storage of the chat bot module 230.

In some examples, after being trained, the chat bot module 230 generates a response to a new query. The chat bot module 230 continuously updates its parameters based on new queries and responses provided to a given client device 110. In some examples, the chat bot module 230 can receive feedback from a given user that is in positive or negative form with respect to one or more responses generated by the chat bot module 230. For example, a user input can be received indicating that a particular response is helpful or interesting. In response, the chat bot module 230 can update the parameters of the machine learning model to reflect a greater weight to the parameters used to generate the particular response. As another example, a user input can be received indicating that a particular response is not helpful or not interesting. In response, the chat bot module 230 can update the parameters of the machine learning model to reflect a lower weight to the parameters used to generate the particular response.

The cloned conversation data module 221 can present a graphical user interface to a first client device 110 that includes a set of messages exchanged between the first user and the chat bot module 230. The first client device 110 can receive input from a first user that identifies a first set of messages of the set of messages that were exchanged. The first client device 110 can also receive data from the first user that explains the context of the first set of messages. The first client device 110 can identify one or more parameters of the chat bot module 230 that were used to generate the messages in the first set of messages. The first client device 110 can generate a message or communication that includes any combination of the first set of messages, context of the first set of messages, and/or the one or more parameters of the chat bot module 230 that have been identified. The message can be encrypted by the first client device 110 and sent to one or more recipient client devices 110. In some examples, the message can be shared on a social media network or website with the explanation of the context. In some examples, the message can be sent directly to the recipient client devices 110, such as by way of a text message.

In some examples, the message or communication can be accessed by the one or more users via the cloned conversation data module 221 on their respective client devices 110. For example, a second user can use a second client device 110 to browse a set of explanations of context received from one or more other client devices 110 on a website or social media network page. The second client device 110 can receive input from the second user that selects a particular message that is associated with the first set of messages identified by the first client device 110. In response, the second client device 110 can provide the identity of the first set of messages to the cloned conversation data module 221. The cloned conversation data module 221 can decrypt the contents of the message to retrieve the first set of messages, context of the first set of messages, and/or the one or more parameters of the chat bot module 230 that have been identified as used to generate the first set of messages. In some examples, the message or communication is tied or associated with a non-fungible token (NFT). In such cases, the cloned conversation data module 221 can access the data associated with the message through the NFT.

The cloned conversation data module 221 can then train or update the parameters of the chat bot module 230 associated with the second client device 110 based on the contents of the message to retrieve the first set of messages, context of the first set of messages, and/or the one or more parameters of the chat bot module 230 that have been identified as used to generate the first set of messages. In this way, when the second client device 110 receives a query, the chat bot module 230 can generate a response to the query using the context of the previous interactions the first user had with the chat bot module 230 associated with the first client device 110. Namely, the chat bot module 230 of the second client device 110 can generate responses for presentation to the second user using previously trained parameters of the chat bot module 230 associated with the first client device 110.

In some examples, the cloned conversation data module 221 provides a method for sharing a conversation between a user and an AI by facilitating the transmission or broadcasting of metadata, acting as digital DNA or parameters acting as an ego for the AI, over a communication network. The initiation of a share may be facilitated through a one-to-one basis like text messaging, or broadcast or posted in an online format such as social networking. The conversation of interest, detailed in the message or share, through either video, text, or audio, represents a newsworthy, interesting, or engaging conversation between user one and their AI. The second users engaging in the share may “adopt” the share that integrates the metadata and parameters into a new version of the conversation optimized around the second user. The share method enables the host invitations or shares to reach a massive plurality of users in proximity of the current location or with a common interest requesting indications of willingness to adopt the conversation.

In some examples, the cloned conversation data module 221 includes a metadata architecture and system for transmission and adoption of metadata from one AI to another AI to facilitate a similar, dynamic conversation between user two and user two's AI based on the context of the conversation between user one and user one's AI. In some implementations, network functionality to enable location-based conversations that reside within a geo-fenced area where such conversations can only be adopted by users operating client devices 110 within the geofence. Stumbling upon the geofence area will result in a query that exposes tertiary users to be shared conversation in response to receiving, from a third user device, an indication of willingness to capture content from the current location, causing the third user device to send the content to the second user device. A new participant may then connect to earlier users and share their contributions for remote viewing by previous users. In some examples, the first user who initially shared the conversation receives an adoption notification of their conversation's adoption. In some examples, the client device 110 of the adopting user (the user who adopted the conversation into their own chat bot) may send a note, either anonymously or with identity, to the first user.

In some examples, the cloned conversation data module 221 can detect that a client device 110 leaves a geotagged boundary. In response, the cloned conversation data module 221 initiates the discovery of shared conversation with the second user, thereby triggering their device to receive a notification indicating availability of the conversation. The cloned conversation data module 221 can receive an indication of a desire to receive the content of the conversation from the second user device and causes the first user device to send the content to the second user device in response to the receiving of the indication of a desire to receive the content from the second user device.

In some examples, the cloned conversation data module 221 customizes a personalized AI to adopt various personalities and characteristics with the intention of future conversation and dialogue. In some cases, the content includes text, audio, or streaming live video. In some cases, the cloned conversation data module 221 accesses user preference data corresponding to intended AI behavior and the input is created using unstructured natural language words or phrases not limited by a predefined list of structured attributes. The user preference data can include metadata to influence the AI's conversational behavior and dynamic, unstructured responses. The metadata from one AI (chat bot module 230) can be influenced by the conversational behavior of a different or even a plurality of AIs. In some cases, the metadata for the AI is automatically generated based on previous actions and even anticipated actions or responses of users interactive with respective client devices 110.

In some examples, the cloned conversation data module 221 includes a remote or local processor to execute machine learning algorithms in the form of conversation instructions made of a service and modules. The cloned conversation data module 221 can include a network graph module, a natural language module, a general pre-training transformer, a location system, and an application logic system, executable by a processor(s), configured to mine intent and understanding from text, audio, and video for tokens generated from a natural language processing method; an object-based model for storing and presenting a plurality of user messages and parameters; and a shared transformer that integrates different AI bot parameters across conversations that have been shared and adopted. The cloned conversation data module 221 includes a user preference module configured to access user preference data corresponding to an ongoing conversation with an AI. In some cases, the first user device can send or receive conversation context based on the user preference data. The user preference data can include a communication relating to registration of users from adopted conversations with the service.

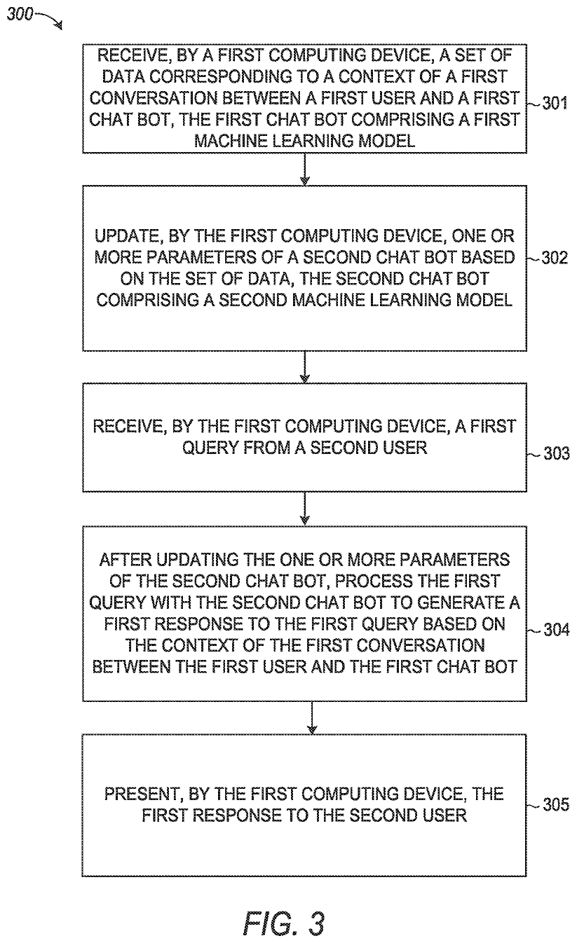

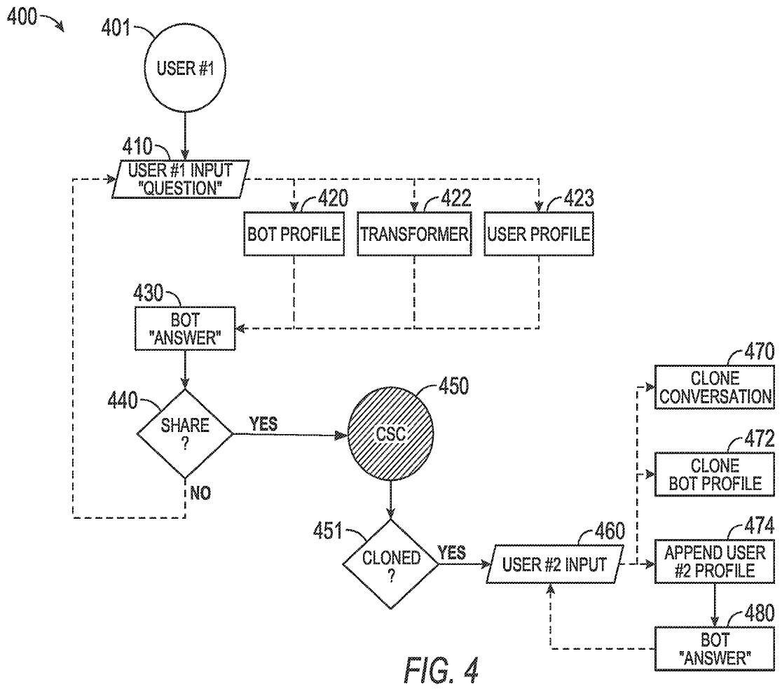

FIGS. 3 and 4 illustrate flow diagrams of processes of the AI-bot sharing system 124, according to some examples. The processes 300 and 400 may be embodied in computer-readable instructions for execution by one or more processors such that the operations of the processes 300 and 400 may be performed in part or in whole by the functional components of the server system 108; accordingly, the processes 300 and 400 are described below by way of example with reference thereto. However, in other examples, at least some of the operations of the processes 300 and 400 may be deployed on various other hardware configurations. The processes 300 and 400 are therefore not intended to be limited to the server system 108 and can be implemented in whole, or in part, by any other component. Any operation in the processes 300 and 400 can be performed in any order or entirely omitted and skipped.

At operation 301, a computing system (e.g., server system 108) receives a set of data corresponding to a context of a first conversation between a first user and a first chat bot, the first chat bot comprising a first machine learning model, as discussed above.

At operation 302, the computing system updates one or more parameters of a second chat bot based on the set of data, the second chat bot comprising a second machine learning model, as discussed above.

At operation 303, the computing system receives a first query from a second user, as discussed above.

At operation 304, the computing system after updating the one or more parameters of the second chat bot, processes the first query with the second chat bot to generate a first response to the first query based on the context of the first conversation between the first user and the first chat bot, as discussed above.

At operation 305, the computing system presents the first response to the second user, as discussed above.

At operation 401, a first user accesses the server system 108 through a first client device 110, as discussed above.

At operation 410, a first query is received from the first client device 110.

At operation 420, a bot profile, such as the chat bot module 230 (e.g., a first chat bot) is used to process the query. At operations 422 and 423, the chat bot module 230 accesses the transformation module 252 and the user profile module 260 to further refine and parse the query to formulate and generate a response.

At operation 430, the response generated by the chat bot module 230 is presented to the first user on the first client device 110.

At operation 440, a determination is made as to whether input from the first user is received by the first client device 110 that identifies a portion of the interaction and conversation to share. If so, the option 450 is performed to send one or more messages that include data associated with the identified portion of the conversation and interaction of the first user to one or more recipients.

At operation 451, a determination is made as to whether input is received from a second client device 110 of one of the recipients to clone or adopt the data associated with the identified portion of the conversation and interaction of the first user. If so, at operation 460, user input is received and at operation 470 the data associated with the identified portion of the conversation and interaction of the first user is processed by the cloned conversation data module 221 to update one or more parameters of a second chat bot (e.g., the chat bot module 230 associated with the second client device 110). This results in the generation of a clone bot profile of the second chat bot.

At operation 460, input comprising a query is received by the second client device 110 and is provided to the second chat bot of the second client device 110. At operation 472, the cloned bot profile of the second chat bot is accessed and used to process the query received by the second client device 110. A user profile associated with the second client device 110 is retrieved at operation 474 and used to generate a response.

At operation 480, the response generated by the cloned bot profile and the user profile associated with the second client device 110 is presented to the second user on the second client device 110. The response is generated based on the data associated with the identified portion of the conversation and interaction of the first user and the first chat bot.

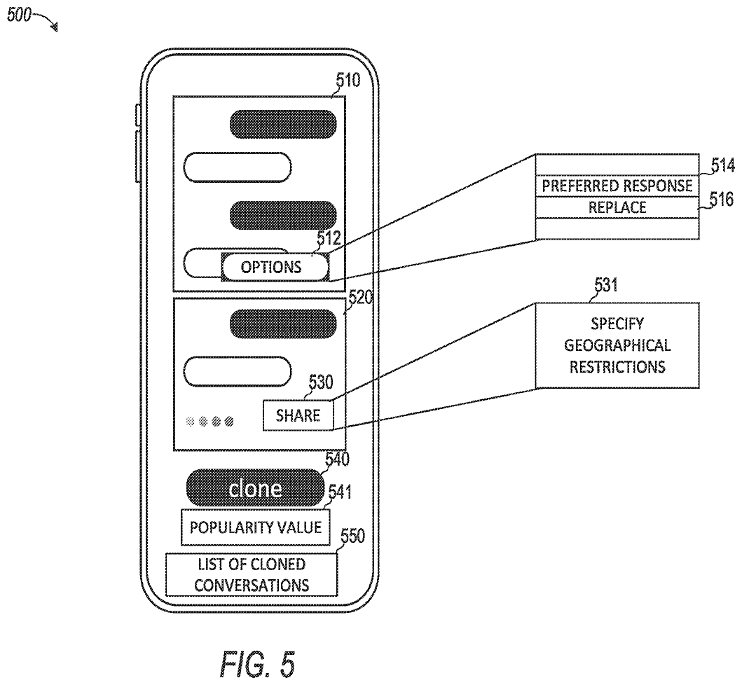

FIG. 5 is an illustrative graphical user interface 500 of the AI-bot sharing system 124, according to some examples. The graphical user interface 500 can be provided on a first client device 110. The graphical user interface 500 can include a conversation that includes a first conversation segment 510 and a second conversation segment 520. The first conversation segment 510 includes a plurality of messages exchanged between a first user and a first AI-chat bot (e.g., the chat bot module 230) associated with the first client device 110.

For example, the first client device 110 can receive a first query from the first user. The first client device 110 can process the query with the first AI-chat bot to generate one or more responses. These interactions are presented in the first conversation segment 510. In some examples, an option 512 can be presented within the first conversation segment 510. The option can be presented in response to receiving input from the first user on the first client device 110, such as a gesture in which a response generated by the first AI-chat bot is selected. The response can be selected through a press and hold operation in which a finger of the first user is held on top of the response for a threshold period of time. In some cases, the response can be selected by swiping a finger across the response in a particular direction. In response to selecting the response, the option 512 is presented in which the user can provide feedback about the response. The feedback can be positive or negative. Positive feedback can be used by the first AI-chat bot to update the parameters of the associated machine learning model to increase weights associated with the parameters that were used to generate the response to the particular query or set of queries. Negative feedback can be used by the first AI-chat bot to update the parameters of the associated machine learning model to decrease weights associated with the parameters that were used to generate the response to the particular query or set of queries. For example, a preferred response option 514 can be selected to indicate that the first user likes or prefers this type of response as positive feedback. A replace option 516 can be selected to input a replacement for the response. Selection of the replace option 516 can be used to provide negative feedback to update the parameters used to generate the response.

In some examples, messages or queries received from the first user or first client device 110 can be displayed in a first format (e.g., with a first color or style). Responses generated based on the queries by the first AI-chat bot can be displayed in a different second format (e.g., with a second color or style). This enables the first user to visually differentiate the queries from the responses.

The second conversation segment 520 includes a plurality of messages exchanged between the first user and the first AI-chat bot (e.g., the chat bot module 230) associated with the first client device 110. The second conversation segment 520 can present a share option 530. The share option 530 can be presented in response to receiving input from the first user on the first client device 110, such as a gesture in which a response generated by the first AI-chat bot is selected or in which a collection of messages (queries and responses) in the second conversation segment 520 are selected. The response or collection of messages can be selected through a press and hold operation in which a finger of the first user is held on top of the response or collection of messages for a threshold period of time. In some cases, the response or collection of messages can be selected by swiping a set of fingers across the response in a particular direction.

In response to receiving input that selects the share option 530, a set of share criteria 531 can be presented. The share criteria 531 can allow the first user to input designated recipients, whether to encrypt the contents of the second conversation segment 520, specify geographical restrictions for the second conversation segment 520 (e.g., a GPS location and threshold distance), input one or more destinations, such as social media networks or websites to post the message, and/or input an explanation of the context of the second conversation segment 520. Based on the share criteria 531 that is associated with the second conversation segment 520, the first client device 110 can share the contents of the second conversation segment 520 or data representing context of the second conversation segment 520. The geographical restrictions can control whether the data representing the context of the second conversation segment 520 is presented to client devices 110 in certain regions. If a geographical location of a recipient client device 110 is within the threshold distance of the GPS location specified in the share criteria 531, then the explanation or data representing the second conversation segment 520 can be made available and presented to the recipient for selection and adoption. If a geographical location of a recipient client device 110 is beyond the threshold distance of the GPS location specified in the share criteria 531, then the explanation or data representing the second conversation segment 520 is prevented from being made available and presented to the recipient for selection and adoption.

In some examples, the first client device 110 can present a list of cloned conversations option 550. In response to receiving input that selects the list of cloned conversations option 550, the first client device 110 can access a website or social media network that lists in ranked order one or more explanations or contexts of conversations other users had with their respective AI-chat bots and shared with the first client device 110. The list can be ranked based on the quantity of times each conversation has been adopted into another user's AI chat bot. For example, each time a given conversation is selected to be adopted, a counter is incremented. The counter is used to determine popularity of each conversation and to generate the ranked list of conversations. As referred to herein, “conversation” is used to refer to an explanation or data associated with context of a conversation and may or may not refer to the actual content of the conversation itself.

In response to receiving a user selection of a given conversation in the list that is presented on the first client device 110, a clone option 540 is presented. Together with the clone option 540, the popularity value 541 associated with the selected conversation is also presented indicating how many times the particular conversation was adopted by other client devices 110. In response to receiving a selection of the clone option 540, the data associated with the selected conversation (of a second user and their respective chat bot) is used to update the first AI-chat bot of the first user. Now, context of the first AI-chat bot will be based on the context of the second user and their respective chat bot when the first AI-chat bot provides responses to a query received from the first user. In some cases, the conversation can be selected from the list without revealing the content of the conversation to any user. Namely, a brief explanation of the conversation can be provided to represent the conversation and the conversation can be associated with parameters of a machine learning model used to generate the conversation. When the conversation is selected, the machine learning model parameters of the second AI-chat bot are retrieved in a way that does not reveal content of the conversation. These parameters of the second AI-chat bot are used to update the parameters of the first AI-chat bot.

In some examples, in response to receiving the selection of the clone option 540, a notification is automatically or manually sent to the second client device 110 of the second user associated with the selected conversation. Namely, the first user can request to adopt the context of the selected conversation that the second user had with their respective second AI-chat bot. In response, the second user receives a message that identifies the first user or that keeps the first user anonymous and that indicates that another user has adopted the selected conversation. In some cases, a popularity value 541 is displayed alongside the conversation segment (e.g., the second conversation segment 520) that has been shared and used by other users to adapt their respective AI-chat bots.

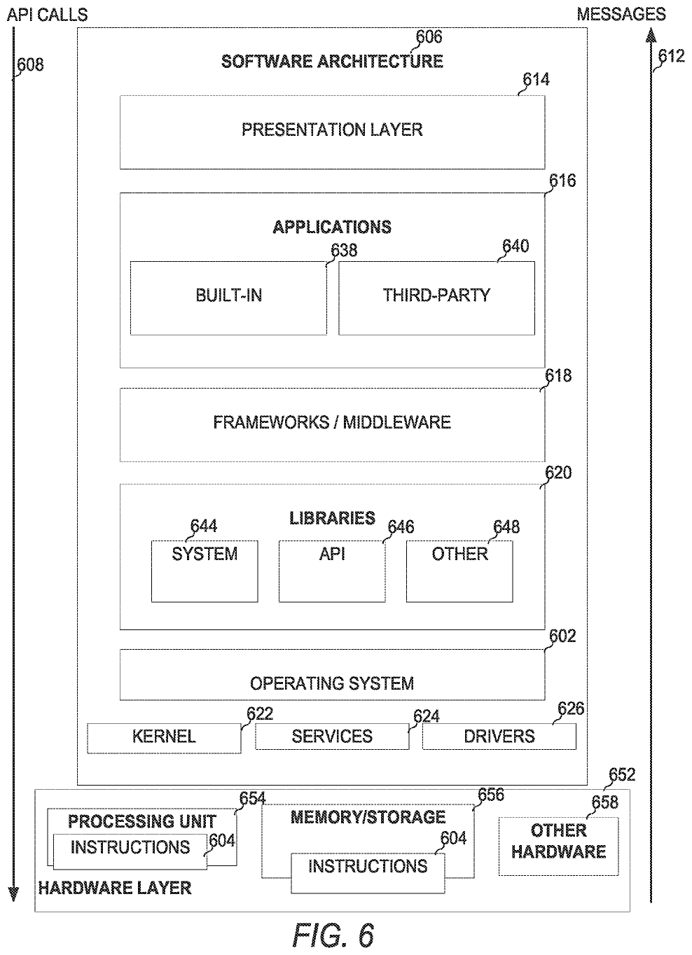

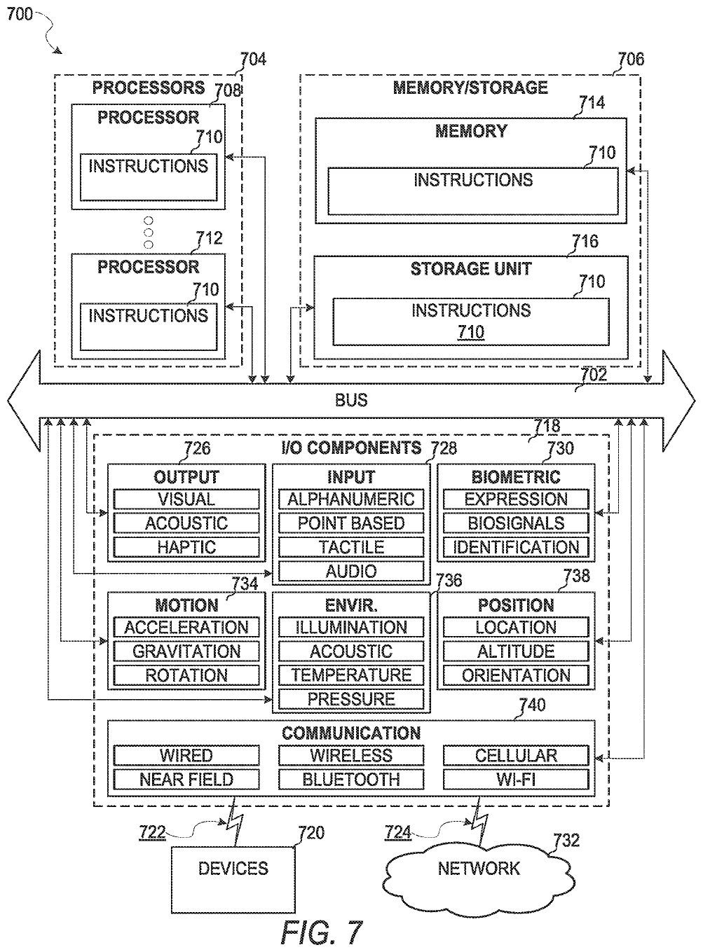

FIG. 6 is a block diagram illustrating software architecture 606, which can be installed on any one or more of the devices described above. For example, in various examples, client devices 110 and servers and systems 130, 108, 120, 122, and 124 may be implemented using some or all of the elements of software architecture 606. FIG. 6 is merely a non-limiting example of a software architecture, and it will be appreciated that many other architectures can be implemented to facilitate the functionality described herein. In various examples, the software architecture 606 is implemented by hardware (including a presentation layer 614, a hardware layer 652 with processing unit 654, memory/storage 656, and other hardware 658) such as machine 700 of FIG. 7 that includes processors 704, memory/storage 706, and input/output (I/O) components 718. As explained below, the processing unit 654 is configured to execute instructions 604 that are stored in memory/storage 656. In this example, the software architecture 606 can be conceptualized as a stack of layers where each layer may provide a particular functionality. For example, the software architecture 606 includes layers such as an operating system 602, libraries 620, frameworks 618, and applications 616. Operationally, the applications 616 invoke API calls 608 through the software stack and receive messages 612 in response to the API calls 608, consistent with some examples.

In various implementations, the operating system 602 manages hardware resources and provides common services. The operating system 602 includes, for example, a kernel 622, services 624, and drivers 626. The kernel 622 acts as an abstraction layer between the hardware and the other software layers, consistent with some examples. For example, the kernel 622 provides memory management, processor management (e.g., scheduling), component management, networking, and security settings, among other functionality. The services 624 can provide other common services for the other software layers. The drivers 626 are responsible for controlling or interfacing with the underlying hardware, according to some examples. For instance, the drivers 626 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some examples, the libraries 620 provide a low-level common infrastructure utilized by the applications 616. The libraries 620 can include system libraries 644 (e.g., C standard library) that can provide functions such as memory allocation functions, string manipulation functions, mathematic functions, and the like. In addition, the libraries 620 can include API libraries 646 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 620 can also include a wide variety of other libraries 648 to provide many other APIs to the applications 616.

The frameworks 618 provide a high-level common infrastructure that can be utilized by the applications 616, according to some examples. For example, the frameworks 618 provide various graphic user interface functions, high-level resource management, high-level location services, and so forth. The frameworks 618 can provide a broad spectrum of other APIs that can be utilized by the applications 616, some of which may be specific to a particular operating system 602 or platform.

In some examples, the applications 616 include built-in applications 638 including any one or more of a home application, a contacts application, a browser application, a book reader application, a location application, a media application, a messaging application, a game application, and a broad assortment of other applications such as a third-party application 640. According to some examples, the applications 616 are programs that execute functions defined in the programs. Various programming languages can be employed to create one or more of the applications 616, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 608 provided by the operating system 602 to facilitate functionality described herein.

Some examples may particularly include an AI-chat bot systems application. In certain examples, this may be a stand-alone application that operates to manage communications with a server system such as third-party servers 130 or server system 108. In other examples, this functionality may be integrated with another application. The AI-chat bot systems application may request and display various data related to AI-chat bot systems and may provide the capability for a user to input data related to the objects via a touch interface, keyboard, or using a camera device of machine 700, communication with a server system via I/O components 718, and receipt and storage of object data in memory/storage 706. Presentation of information and user inputs associated with the information may be managed by AI-chat bot systems application using different frameworks 618, library 620 elements, or operating system 602 elements operating on a machine 700.

FIG. 7 is a block diagram illustrating components of a machine 700, according to some examples, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application 616, an applet, an app, or other executable code) for causing the machine 700 to perform any one or more of the methodologies discussed herein can be executed. In alternative examples, the machine 700 operates as a standalone device or can be coupled (e.g., networked) to other machines. In a networked deployment, the machine 700 may operate in the capacity of a server 130, 108, 120, 122, 124, etc., or a client device 110 in a server-client network environment, or as a peer machine in a peer-to-peer (or distributed) network environment. The machine 700 can comprise, but not be limited to, a server computer, a client computer, a personal computer (PC), a tablet computer, a laptop computer, a netbook, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines 700 that individually or jointly execute the instructions 710 to perform any one or more of the methodologies discussed herein.

In various examples, the machine 700 comprises processors 704, memory 714, and I/O components 718, which can be configured to communicate with each other via a bus 702. In an some examples, the processors 704 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 708 and a processor 712 that may execute the instructions 710. The term “processor” is intended to include multi-core processors 704 that may comprise two or more independent processors 704 (also referred to as “cores”) that can execute instructions 710 contemporaneously. Although FIG. 7 shows multiple processors 704, the machine 700 may include a single processor 704 with a single core, a single processor 704 with multiple cores (e.g., a multi-core processor 704), multiple processors 704 with a single core, multiple processors 704 with multiples cores, or any combination thereof.

The memory/storage 706 comprises a main memory 714, a static memory, and a storage unit 716 accessible to the processors 704 via the bus 702, according to some examples. The storage unit 716 can include a machine-readable medium on which are stored the instructions 710 embodying any one or more of the methodologies or functions described herein. The instructions 710 can also reside, completely or at least partially, within the main memory 714, within the static memory, within at least one of the processors 704 (e.g., within the processor's cache memory), or any suitable combination thereof, during execution thereof by the machine 700. Accordingly, in various examples, the main memory 714, the static memory, and the processors 704 are considered machine-readable media.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium is shown, in some examples, to be a single medium, the term “machine-readable medium” should be taken to include a single medium or multiple media (e.g., a centralized or distributed database, or associated caches and servers) able to store the instructions 710. The term “machine-readable medium” shall also be taken to include any medium, or combination of multiple media, that is capable of storing instructions (e.g., instructions 710) for execution by a machine (e.g., machine 700), such that the instructions 710, when executed by one or more processors of the machine 700 (e.g., processors 704), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 718 include a wide variety of components to receive input, provide output, produce output, transmit information, exchange information, capture measurements, and so on. In general, it will be appreciated that the I/O components 718 can include many other components that are not shown in FIG. 7. The I/O components 718 are grouped according to functionality merely for simplifying the following discussion, and the grouping is in no way limiting. In various some examples, the I/O components 718 include output components 726 and input components 728. The output components 726 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 728 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further some examples, the I/O components 718 include biometric components 730, motion components 734, environmental components 736, or position components 738, among a wide array of other components. For example, the biometric components 730 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 include acceleration sensor components (e.g., accelerometer), gravitation sensor components, rotation sensor components (e.g., gyroscope), and so forth. The environmental components 736 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 738 include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 718 may include communication components 740 operable to couple the machine 700 to a network 732 or devices 720 via a coupling 724 and a coupling 722, respectively. For example, the communication components 740 include a network interface component or another suitable device to interface with the network 732. In further examples, communication components 740 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 720 may be another machine 700 or any of a wide variety of peripheral devices (e.g., a peripheral device coupled via a USB).

Moreover, in some examples, the communication components 740 detect identifiers or include components operable to detect identifiers. For example, the communication components 740 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 740, such as location via Internet Protocol (IP) geo-location, location via WI-FI® signal triangulation, location via detecting a BLUETOOTH® or NFC beacon signal that may indicate a particular location, and so forth.

In various some examples, one or more portions of the network 732 can be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a WI-FI® network, another type of network, or a combination of two or more such networks. For example, the network 732 or a portion of the network 732 may include a wireless or cellular network, and the coupling 724 may be a Code Division Multiple Access (CDMA) connection, a Global System for Mobile communications (GSM) connection, or another type of cellular or wireless coupling. In this example, the coupling 722 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In some examples, the instructions 710 are transmitted or received over the network 732 using a transmission medium via a network interface device (e.g., a network interface component included in the communication components 740) and utilizing any one of a number of well-known transfer protocols (e.g., Hypertext Transfer Protocol (HTTP)). Similarly, in other some examples, the instructions 710 are transmitted or received using a transmission medium via the coupling 722 (e.g., a peer-to-peer coupling) to the devices 720. The term “transmission medium” shall be taken to include any intangible medium that is capable of storing, encoding, or carrying the instructions 710 for execution by the machine 700, and includes digital or analog communications signals or other intangible media to facilitate communication of such software.

Furthermore, the machine-readable medium is non-transitory (in other words, not having any transitory signals) in that it does not embody a propagating signal. However, labeling the machine-readable medium “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific some examples, various modifications and changes may be made to these examples without departing from the broader scope of examples of the present disclosure

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. The specification and drawings are, accordingly, to be regarded in an illustrative rather than a restrictive sense.

What is claimed is:

1. A method comprising:
receiving, by a first computing device, a set of data corresponding to a context of a first conversation between a first user and a first chat bot, the first chat bot comprising a first machine learning model;
updating, by the first computing device, one or more parameters of a second chat bot based on the set of data, the second chat bot comprising a second machine learning model;
receiving, by the first computing device, a first query from a second user;
after updating the one or more parameters of the second chat bot, processing the first query with the second chat bot to generate a first response to the first query based on the context of the first conversation between the first user and the first chat bot; and
presenting, by the first computing device, the first response to the second user.

2. The method of claim 1, further comprising:
accessing at least one of an information source or a profile associated with the second user to generate the first response.

3. The method of claim 1, wherein the set of data comprises a portion of the first conversation between the first user and the first chat bot, the method further comprising:
training, based on training data, the second machine learning model of the second chat bot to generate one or more responses, the training data comprising the portion of the first conversation between the first user and the first chat bot, the second machine learning model being trained to establish a relationship between one or more training contexts of one or more conversations and one or more ground-truth responses.

4. The method of claim 1, wherein the set of data comprises a portion of parameters of the first machine learning model corresponding to the first conversation, the method further comprising:
updating, based on the portion of the parameters of the first machine learning model, one or more parameters of the second machine learning model of the second chat bot to generate one or more responses, the second machine learning model being trained to establish a relationship between one or more training contexts of one or more conversations and one or more ground-truth responses.

5. The method of claim 4, further comprising:
generating the portion of parameters of the first machine learning model by identifying a subset of parameters of the first machine learning model that correspond to features of the first conversation to.

6. The method of claim 1, wherein the receiving of the set of data comprises:
receiving, from the first client device of the first user, a message from the first user, the message comprising a link to the set of data; and
in response to receiving a request from a second client device of the second user to adopt the context of the first conversation between the first user and the first chat bot, accessing the link to retrieve the set of data.

7. The method of claim 6, wherein the message is received as at least one of a text, video, or audio message, a post to a social network, a meta package as an ingredient to assimilate into another conversation factor, or content on a webpage.

8. The method of claim 6, further comprising:
in response to receiving the request to adopt the context, accessing location information of the second client device;
accessing one or more geographical restrictions associated with adopting the context of the first conversation between the first user and the first chat bot;
determining that the location information of the second client device satisfies the one or more geographical restrictions associated with adopting the context of the first conversation between the first user and the first chat bot; and
controlling presentation of the message on the second client device based on determining that the location information of the second client device satisfies the one or more geographical restrictions.

9. The method of claim 6, wherein the message is displayed to client devices that are within a threshold distance of one or more geographical restrictions associated with adopting the context of the first conversation between the first user and the first chat bot.

10. The method of claim 6, further comprising:
transmitting a notification to the first client device of the first user in response to receiving the request from the second client device, the notification informing the first user that the context of the first conversation has been adopted by one or more other users.

11. The method of claim 10, wherein the notification identifies the second user to the first user.

12. The method of claim 10, wherein the one or more other users remain anonymous to the first user.

13. The method of claim 1, further comprising:
updating the one or more parameters of the second chat bot without sharing or revealing content of the first conversation between the first user and the first chat bot.

14. The method of claim 1, wherein prior to updating the one or more parameters of the second chat bot, the second chat bot is configured to generate a second response to the first query that is different from the first response.

15. The method of claim 1, wherein the first query comprises one or more unstructured natural language words or phrases or graphical representations such as emojis; and
wherein the first response comprises one or more unstructured responses.

16. The method of claim 1, further comprising:
generating the first conversation in response to a plurality of interactions between the first user and the first chat bot, the plurality of interactions comprising a set of queries and corresponding responses;
receiving a first input from the first user that selects a portion of the plurality of interactions; and
identifying the context based on the selected portion of the plurality of interactions, the set of data being generated based on the identified context.

17. The method of claim 16, further comprising:
receiving a second input from the first user to share the identified context of the first conversation with one or more other users through at least one of an encrypted message or a non-fungible token (NFT).

18. The method of claim 1, further comprising:
receiving input from the second user that comprises at least one of positive or negative feedback in relation to the first response; and
updating at least one additional parameter of the second chat bot based on the at least one of positive or negative feedback.

19. A system comprising:
a memory that stores instructions; and
one or more processors configured by the instructions to perform operations comprising:
receiving a set of data corresponding to a context of a first conversation between a first user and a first chat bot, the first chat bot comprising a first machine learning model;
updating one or more parameters of a second chat bot based on the set of data, the second chat bot comprising a second machine learning model;
receiving a first query from a second user;
after updating the one or more parameters of the second chat bot, processing the first query with the second chat bot to generate a first response to the first query based on the context of the first conversation between the first user and the first chat bot; and
presenting the first response to the second user.

20. A non-transitory computer-readable medium comprising instructions stored thereon that are executable by at least one processor to cause the at least one processor to perform operations comprising:
receiving a set of data corresponding to a context of a first conversation between a first user and a first chat bot, the first chat bot comprising a first machine learning model;
updating one or more parameters of a second chat bot based on the set of data, the second chat bot comprising a second machine learning model;
receiving a first query from a second user;
after updating the one or more parameters of the second chat bot, processing the first query with the second chat bot to generate a first response to the first query based on the context of the first conversation between the first user and the first chat bot; and
presenting the first response to the second user.
